(19) United States
(12) Patent Application Publication
(10) Pub. No.: US 2024/0008465 A1
(43) Pub. Date: Jan. 11, 2024

(54) ARTIFICIAL BAIT MATERIAL WITH INTEGRAL TYING THREAD, METHOD OF MAKING AND MOLD

(71) Applicant: Hooky Company LLC, Upper Black Eddy, PA (US)

(72) Inventor: Billy Joe Pyle, Upper Black Eddy, PA (US)

(73) Assignee: Hooky Company LLC, Upper Black Eddy, PA (US)

(21) Appl. No.: 17/858,467

(22) Filed: Jul. 6, 2022

(51) Int. Cl. A01K 85/00; A01K 85/01; B29C 45/14

(52) U.S. Cl. CPC A01K 85/1897; A01K 85/018; A01K 85/1821; B29C 45/14065; B29K 2101/12

(57) ABSTRACT

An artificial bait material for use in a simulated bait assembly. The artificial bait material includes a body that is formed from a thermoplastic elastomer (TPE) such as PLASTISOL. In addition, the artificial bait material include a thread component having a first portion that is formed within the body of the artificial bait material, and a second portion that extends out of and away from the body. In this configuration, for example, the material can be used to form a fly lure by tying the second portion of the thread component directly to the hook or barb of the lure with fly tying thread, without having to wrap either thread around the body of the artificial bait material. As a result, the fly tying thread can be tightly tied to the hook or barb without risk of cutting through the body of the artificial bait material.

### FIELD OF THE INVENTION

This disclosure pertains to an artificial bait material with an integral tying thread for use in fishing lures, and more particularly, to a flexible artificial bait material with an integral tying thread for use in fly fishing lures, together with an associated method of manufacture and mold fixture.

### BACKGROUND

Artificial bait materials have been used for decades to imitate prey or prey characteristics such as color, flash, or shape, that sport fish find attractive. In contrast to natural bait, artificial baits most often tend to be reusable and have substantial shelf life. While there are hundreds of different types of artificial lures that can be crafted from artificial materials, most fall into a relatively small number of conventional categories including for example crank baits, plugs, poppers, spoons, jigs, spinners, and flies.¹

Flexible bait materials (for example, as are often made from elastomeric materials) can be particularly advantageous in simulating movement and motion of prey in the water. These materials have used quite successfully, for example, to simulate worm prey in fly lure applications. In these applications, the elastomeric material is typically fastened to a small hook or barb by means of thread wraps tied tightly around both the material and hook or barb. This procedure however can be problematic. If the thread wraps are tied too loosely, the elastomeric material may become separated from the hook or barb during use. If tied too tightly, the thread wraps may cut through the elastomeric material, thereby causing this material and its connection to the hook or barb to fail.

It would be beneficial to develop a mechanism by which an elastomeric material may be more conveniently and reliably fastened to a hook or barb, for example, such as are conventionally used in the tying of fly lures. 1 See, e.g., “Discover Boating,” National Marine Association, https://www.discoverboating.com/resources/fishing-natural-bait-vs-artificial-lures (last visited Apr. 24, 2022).

### SUMMARY

By way of example, aspects of the present disclosure are directed to an artificial bait material for use in a simulated bait assembly. The artificial bait material includes a body that is preferably formed from a thermoplastic material by injection molding, and more preferably from a thermoplastic elastomer (TPE) such as PLASTISOL. In addition, the artificial bait material include a bait thread component having a first portion that is formed within the body of the artificial bait material, and a second portion that extends out of and away from the body. In this configuration, for example, the material can be used to form a fly lure by tying the second portion of the thread component directly to the hook or barb of the lure with fly tying thread, without having to wrap either thread around the body of the artificial bait material. As a result, the fly tying thread can be tightly tied to the hook or barb without risk of cutting through the body of the artificial bait material.

In accordance with aspects of the present disclosure, the bait thread component may comprise a fusible thread. For improved retention within the body of the artificial bait material, the second portion of bait thread component may include topological features, for example, such as knots.

In accordance with an additional aspect of the present disclosure, the body may also include one or more additives selected from the group consisting of glitter, flecks, pearlescents, inks, dyes, scents and attractants are incorporated within the PLASTISOL material.

In accordance with another aspect of the present disclosure, the artificial bait material may be assembled together with a hook or barb component to form a fishing lure.

In accordance with further aspects of the disclosure, the artificial bait material may be produced by a mold having a feeder sprue for receiving a liquid mold material, one or more cavities in fluid communication with the feeder sprue that are shaped to form a body of the simulated bait material, and one or more channels extending from each of the one or more cavities for receiving a thread portion of the artificial bait material.

In accordance with other aspects of the disclosure, a method is disclosed for making the artificial bait material, including the steps of providing a mold having at least one cavity shaped to form a body of an artificial bait element of the artificial bait material and at least one channel extending away from the cavity and terminating at an edge of the mold, routing a thread through the at least one cavity and at least one channel, introducing a flowable thermoplastic material into the cavity, and removing the simulated bait assembly from the mold after a predetermined curing period. The channel is preferably configured to be substantially filled by the thread, thereby providing resistance to prevent the flowable thermoplastic material from entering the channel.

In accordance with further aspects of the disclosure, a method is disclosed for making an artificial bait material, wherein the flowable thermoplastic material is PLASTISOL introduced into the mold cavity at a temperature between 345 degrees Fahrenheit and 365 degrees Fahrenheit, and a portion of a fusible thread molded into the body of an artificial bait element of the artificial bait material in proximity to an end of the body from which the a thread component extends is fused into an expanded, ball-like shape that anchors the fusible thread within the body.

In accordance with additional aspects of the disclosure, a method is disclosed for making a fishing lure that includes the artificial bait material, including the steps of providing at least one simulated bait assembly from the artificial bait material that includes a body simulating a predetermined bait type and a thread component having a first portion integrally formed within the body and a second portion extending out of and away from the body, providing a hook having a shank portion, positioning the second portion of the thread component along the shank portion of the hook, and affixing the second portion of the thread component to the shank portion of the hook by wrapping a tying thread around each of these elements and securing a wrapping end of the tying thread to the fishing lure.

This SUMMARY is provided to briefly identify some aspects of the present disclosure that are further described below in the DESCRIPTION. This SUMMARY is not intended to identify key or essential features of the present disclosure nor is it intended to limit the scope of any claims.

### BRIEF DESCRIPTION OF THE DRAWING

A more complete understanding of the present disclosure may be realized by reference to the accompanying drawing in which:

FIG. 1A provides a schematic drawing illustrating an artificial bait material manufactured in accordance with aspects of the present disclosure;

FIG. 1B provides a schematic drawing of a portion of the artificial bait material of FIG. 1A illustrating an additional aspect of the present disclosure;

FIG. 2 provides a schematic drawing depicting an exemplary fly lure incorporating an artificial bait material manufactured in accordance with aspects of the present disclosure;

FIG. 3 provides a schematic drawing illustrating a tying operation used to prepare the fly lure illustrated in FIG. 2;

FIG. 4A provides a schematic drawing depicting an interior forming surface of a first part of a two-part mold for making the artificial bait material of FIG. 1A in accordance with aspects of the present disclosure;

FIG. 4B provides a schematic drawing depicting a top surface of the first part of the two-part mold of FIG. 4A;

FIG. 5A provides a schematic drawing depicting an interior forming surface of a second part of the two-part mold for making the artificial bait material of FIG. 1A in accordance with aspects of the present disclosure;

FIG. 5B provides a schematic drawing depicting a top surface of the second part of the two-part mold of FIG. 5A;

FIG. 6 provides a schematic drawing illustrating a side surface of the first part of the two-part mold of FIG. 4A;

FIG. 7 provides a schematic drawing illustrating the artificial bait material of FIG. 1A as removed from the two-part mold illustrated in FIGS. 4A-6;

FIG. 8 provides a flow diagram illustrating a method for making an artificial bait material in accordance with aspects of the present disclosure; and

FIG. 9 provides a flow diagram illustrating a method for preparing an elastomeric material for use in the method illustrated by FIG. 8.

### DETAILED DESCRIPTION

The following merely illustrates the principles of the disclosure. It will thus be appreciated that those skilled in the art will be able to devise various arrangements which, although not explicitly described or shown herein, embody the principles of the disclosure and are included within its spirit and scope.

Furthermore, all examples and conditional language recited herein are principally intended expressly to be only for pedagogical purposes to aid the reader in understanding the principles of the disclosure and the concepts contributed by the inventor(s) to furthering the art, and are to be construed as being without limitation to such specifically recited examples and conditions.

Moreover, all statements herein reciting principles, aspects, and embodiments of the disclosure, as well as specific examples thereof, are intended to encompass both structural and functional equivalents thereof. Additionally, it is intended that such equivalents include both currently known equivalents as well as equivalents developed in the future, i.e., any elements later developed that perform the same function, regardless of structure.

Unless otherwise explicitly specified herein, the drawings are not drawn to scale.

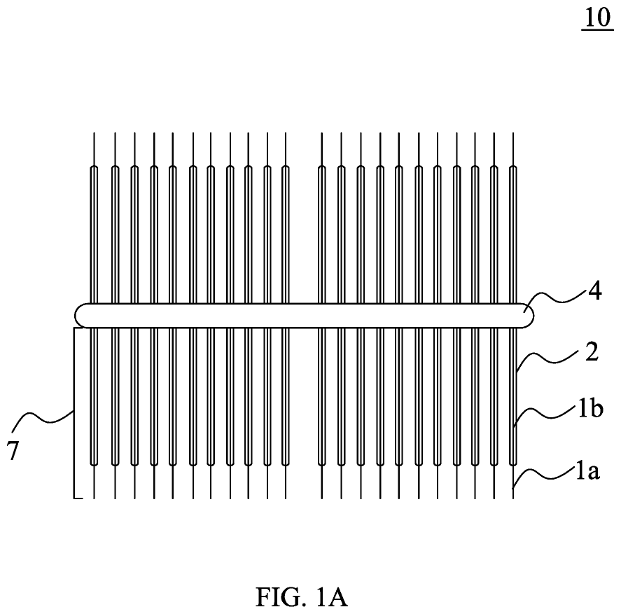

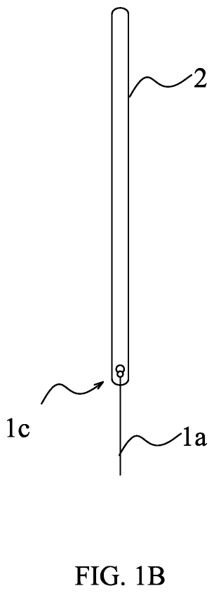

Aspects of the present disclosure are directed to an artificial bait material 10 for use in a simulated bait assembly as depicted for example in FIG. 1A. The artificial bait material 10 includes one or more artificial bait elements 7 having a body 2 that is preferably formed from a thermoplastic elastomer (TPE) such as PLASTISOL. In addition, each artificial bait element 7 includes thread components 1a, 1b having a first portion 1b that is formed and retained within the body 2, and a second portion 1a that extends out of and away from the body 2. In this configuration, for example and as depicted in FIG. 2, one or more artificial bait elements 7 can be coupled with a hook 6 to form a fishing lure 8 (for example, depicted as a fly lure in FIG. 2).

As depicted by way of example in FIG. 1A, the artificial bait material 10 includes a plurality of artificial bait elements 7 that are attached to and branch perpendicularly away from a runner 4. In use, each artificial bait element 7 can be pinched or otherwise severed from runner 4 for individual use. As illustrated by way of example in FIG. 1A, the bodies 2 of the artificial bait elements 7 are each formed in a thin tubular shape as might be used for example to simulate a bait worm. It should be understood that this thin tubular shape of the bodies 2 is adopted herein for illustration purposes only, and is not intended in any way to be limiting. In accordance with the present disclosure, bodies 2 may be formed having any of a great variety of sizes and shapes, as would be usable in the construction of fishing lures and other artificial baits of all types.

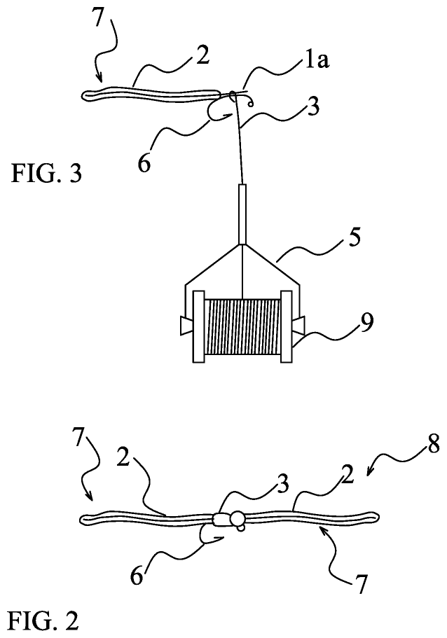

By way of example, FIG. 3 further illustrates a procedure in accordance with aspects of the present disclosure for assembling the fishing lure 8 of FIG. 2. In FIG. 3, the first thread component portion 1a of an artificial bait element 7 is positioned adjacently parallel to the shank. portion of a hook 6. A fly tying thread 3 is supplied from a thread spool 9 mounted on a bobbin 5. An end of the fly tying thread 3 is wrapped tightly in a number of turns around the first thread component portion 1a and the shank of the hook 6 (for example, 5 to 10 turns on a small to medium sized hook)², and then tied off in a conventional manner (for example, using a whip finish).³ In this manner, the artificial bait element 7 is secured to the hook 6 without having to wrap either the thread first thread component portion 1a or the fly tying thread 3 around the body 2 of the artificial bait element 7. As a result, the fly tying thread 3 can be tightly tied to the hook 6 to secure the artificial bait element to the hook 6 without risk of cutting through the body 2 of the artificial bait element 7. ² See, e.g., Hans van Klinken, “How I Came To My Flying Technique https://www.czechnymph.com/en/fly-fishing-articles/fly-tying/11-how-i-came-to-my-tying-technique, last visited May 2, 2022³ See, e.g., Orvis, “How to Use a Whip-Finish Tool,” https://howtoflyfish.orvis.com/one-minute-fly-tying-tips/964-how_to_use_a_whipfinish_tool, last visited Apr. 29, 2022.

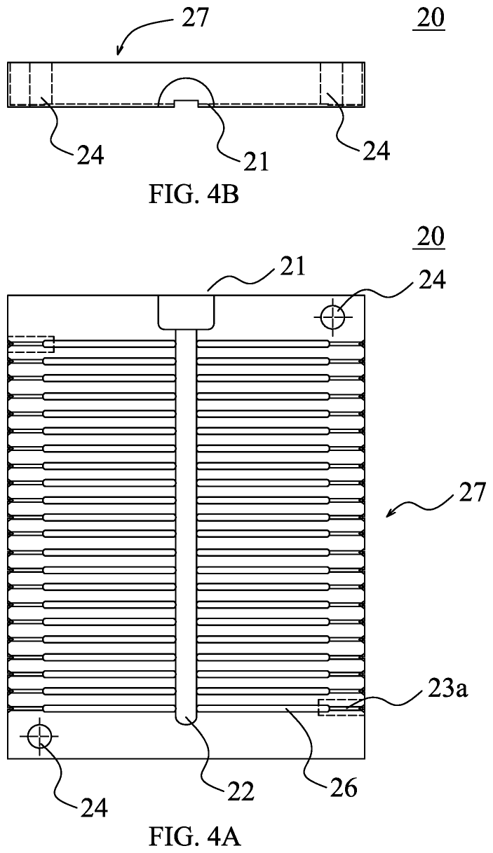

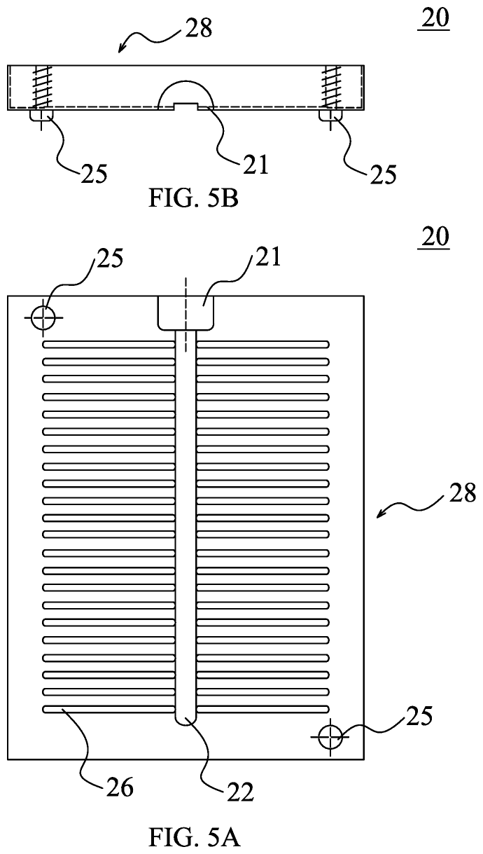

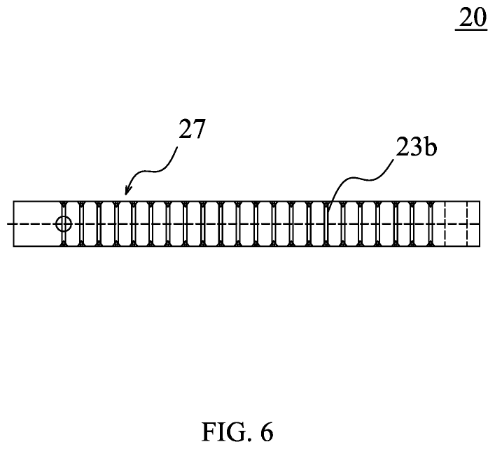

FIGS. 4A-6 provide orthographic schematic views of an exemplary two-piece mold 20 suitable for producing the artificial bait material 10 of FIG. 1A. FIGS. 4A and 4B illustrate front ant top views of a first half 27 of the two-piece mold 20, and FIGS. 5A and 5B illustrate front and top views of a second half 28 of the two-piece mold 20. FIG. 6 illustrates a side view of the first half 27 of the two-piece mold 20.

As illustrated in FIGS. 4A-6, each of the first and second halves 27, 28 of the two-piece mold 20 includes a series of depressions which together form a mold chamber when the front faces of the halves 27, 28 are mated. The chamber includes a sprue 21 for receiving the liquid TPE from an external source, a runner 22 for transferring the liquid TPE to other portions of the mold, and cavities 26 extending outwardly away from the runner 22 for receiving the liquid TPE from the runner 22. When the mold halves 27, 28 are mated, the cavities 26 each form a volume that is shaped for molding a body 2 of the artificial bait material 10. When mated, alignment apertures 24 in the mold half 27 are configured to receive pins 25 in mold half 28 to provide proper alignment for the chamber. First and second haves 27, 28 may include additional aligned apertures (not shown) that may be threaded or otherwise configured to receive fasteners for clamping the halves 27, 28 together in their aligned, mated configuration.

Mold half 27 further includes primary channels 23a that extend outwardly away from each of the cavities 26 to side edges of the mold half 27. As depicted in FIGS. 4a-5B, the exemplary two-piece mold 20 may be prepared, for example, by modifying a commercially-available blood line mold (for example, the 241CI-40 blood line insert mold available from Angling AI of Jackson, Michigan). In a preferred embodiment, and as depicted in FIG. 6, the mold half 27 may be modified to include side channels that extend perpendicularly back and away from the primary channels 23a at the side edges of the mold half 27. Optionally, the side channels 23b may further extend fully or in part across a back surface of the mold half 27, and the mold half 27 may incorporate one or more retention devices (for example, a rubber plug configured to be inserted in an aperture or slot that perpendicularly traverses one or more of the side channels 23b).

One of ordinary skill will readily understand, consistent with the present disclosure, that the mold halves 27, 28 may be configured in many ways according to the size and geometric characteristics of the bodies 2 to be molded. As depicted for example in FIGS. 4A and 5B, the molds are configured to produce forty-four bodies 2 having a blood line shape, with twenty-two of the forty-four bodies 2 extending laterally away from each side of the runner 22. Mold halves 27, 28 may for example be alternatively configured to produce forty bodies extending laterally away from the runner 22. In addition, for example to accommodate heavier bait threads 1a, each of the mold halves 27, 28 may be configured to include primary channels 23a extending laterally away from outwardly away from the cavities 26 in the respective mold half, and may in addition include side channels 23b for retaining bait threads 1a that are wrapped around outer surfaces of the mold halves 27, 28.

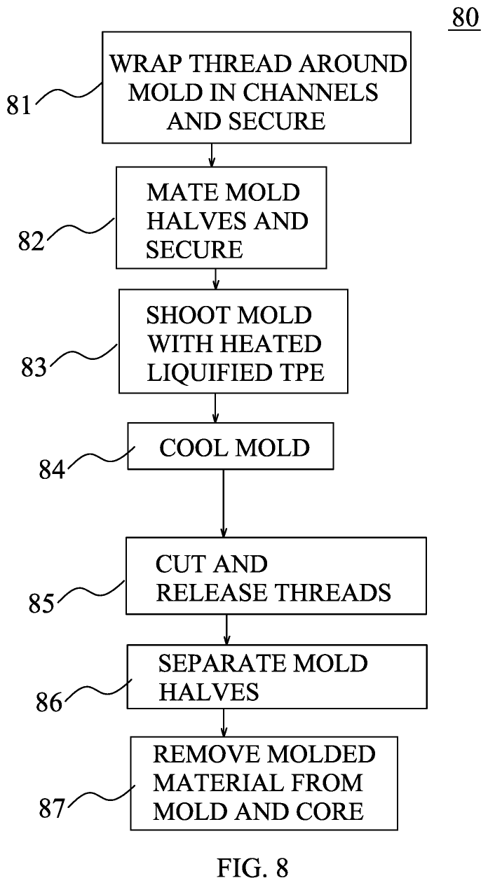

In accordance with additional aspects of the present disclosure, a process 8 for making the artificial bait material 10 is depicted in the flow diagram of FIG. 8. At step 81 of FIG. 8, a bait thread material 1 is wrapped around the mold half 27, such that the thread runs through each of the cavities 26 and channels 23a, 23b of the mold half 27. Ends of the bait thread material 1 may be secured at a side edge or along the back surface of the mold half 27, for example, by taping the thread ends to the mold half 27 or making used of the optional retention device described above. For example, as illustrated in FIG. 6, apertures 29 may be provided in one or more of the side surfaces of the first half 27 of the two-piece mold 20 and configured to receive a tapered rubber plug (not shown) for securing the bait thread material 1 (for example, a tapered ethylene propylene diene monomer (EPDM) rubber stopper having a top diameter of ¼ inch and a bottom diameter of ⅛ inch, as is available from WidgetCo of Houston, Texas).

At step 82 of FIG. 8, mold halves 27, 28 are aligned and mated with one another by means of securing fasteners or other clamping means. Typically, the rubber plugs may be removed from the apertures 29 at this step, as the bait thread material 1 will be sufficiently retained by the clamped mold halves 27, 28.

At step 83, the mold 20 is shot with heated, liquefied TPE that is introduced at sprue 21 and urged therefrom into the runner 22 and cavities 26 by gravity force and/or other mechanical force applied at the sprue 21. With the channels 23a sized essentially to accommodate the diameter of the thread 1, the applied force can be controlled so that the heated, liquefied TPE can be flowed to fill each of the cavities 23a without extending significantly into the channels 23a. For a TPE material such as PLASTISOL, the TPE may for example be heated to a temperature between 370 degrees Fahrenheit and 400 degrees Fahrenheit for liquefied flow into the mold 20. A suitable PLASTISOL material for this purpose may be obtained, for example, from Dead On Plastix LLC of Jackson, Michigan.

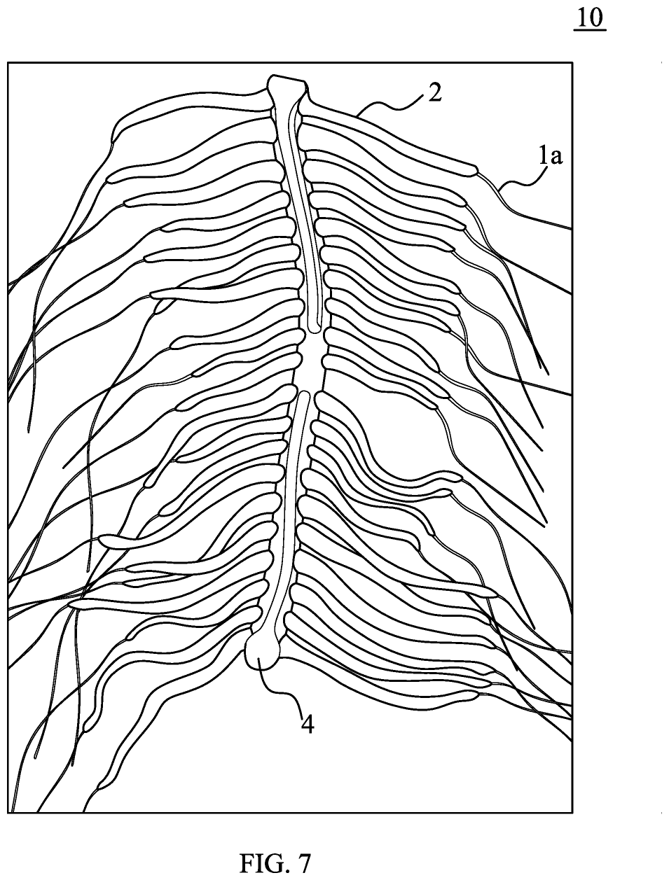

At step 84 of FIG. 8, after the TPE has been flowed into the mold 20, the mold is cooled for a predetermined time period (for example, for two to three minutes) in order to allow the liquid TPE to solidify. At step 85, the thread wraps are cut (for example, along a centerline of the back surface of the mold half 27) and the thread ends are released. At step 86, the mold halves 27, 28 are de-clamped and separated, co that the artificial bait material 10 can be removed from the mold halves 27, 28 at step 87. FIG. 7 illustrates by way of example a bait material 10 after it has been removed from the mold halves 27, 28. Once removed, the artificial bait material 10 is preferably maintained at room temperature for a curing period (for example, for 24 hours) prior to packaging and/or use. As the bodies 2, bait threads 1a and runner material 4 are flexible, the artificial bait material 10 in whole as removed may assume an irregularly-configured shape as depicted in FIG. 7.

In accordance with aspects of the present disclosure, the artificial bait material 10 may be molded in a variety of shapes and sizes, in a variety of colors and having a variety of textures. Preferably, the material 10 is a TPE material including one or more additives such as glitter/flecks, pearlescents, scents, dyes and/or attractants. The size, shape, materials and additives may be selected for example to achieve desired behavioral characteristics (for example, such as buoyancy).

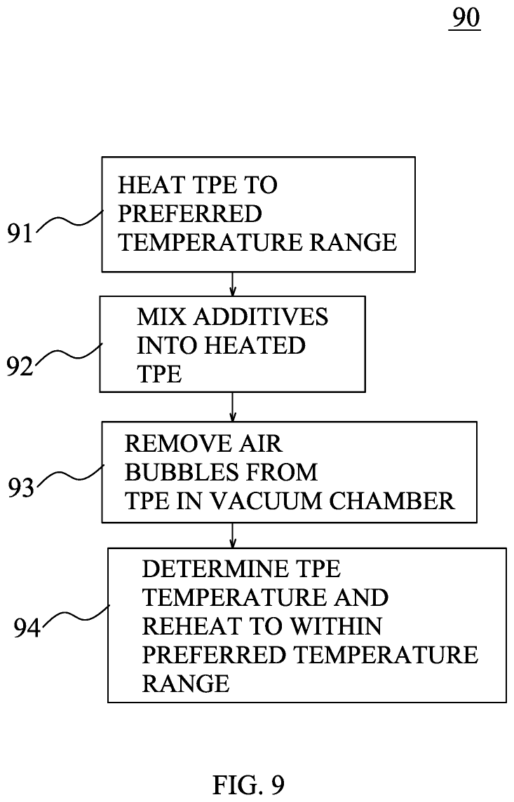

FIG. 9 presents a process flow diagram that illustrates a method of making the TPE material in accordance with aspects of the present disclosure. At step 91 of FIG. 9, the TPE material (for example, PLASTISOL) is heated to a liquefying temperature within a predetermined temperature range (for example, between 380 degrees Fahrenheit and 400 degrees Fahrenheit). Depending on a desired volume and speed of manufacture, a number of commercially-available heating devices may be suitable for this purpose, including for example a microwave oven such as the Magic Chef Model HMM1110B Countertop Microwave available from MCA Corporation of Wood Dale, Illinois, or an electric kettle such as the Presto Model 06006 Kitchen Kettle available from National Presto Industries, Inc. of Eau Claire, Wisconsin. Temperature of the heated PLASTISOL may preferably be confirmed by means of a non-contact thermometer such as the Ryobi IR992 Infrared Thermometer available from Ryobi Tools USA of Anderson, South Carolina.

At step 92, selected additives are added and mixed with the liquefied PLASTISOL. Preferably, the heated mixture is placed in a vacuum chamber at step 93 to remove air bubbles introduced into the PLASTISOL during material handling and additive mixing. One suitable vacuum chamber system for this purpose, for example, is the BACOENG 3 Gallon Vacuum Chamber Kit with 3.6 CFM 1-Stage Vacuum Pump HVAC available from Baco Engineering of Suzhou, Jiangsu, China.

Finally, at step 94, the material is removed from the vacuum chamber, and the temperature of the PLASTISOL is again measured. The mixture is reheated as required to a preferred level (for example, not greater than 370 degrees Fahrenheit) prior to being transferred to the mold 20. In this manner, the temperature of the mixture entering the sprue 21 of the mold 21 may for example measure between 345 degrees Fahrenheit and 365 degrees Fahrenheit.

The bait thread 1a, 1b that has been integrally molded within the bodies 2 of the artificial bait material 10 is preferably a fusible thread (for example, a White TEX 70 available from Amann USA of Broomfield, Colorado, or a GUTERMANN fusible thread available form American & Efird LLC of Mt. Holly, North Carolina). The fusible thread portion 1b is retained in each body 2 primarily by melting and re-solidifying in an integrated manner with the liquid PLASTISOL material as it cools and re-solidifies. The thread portion 1b may also be prepared with knots and/or other topological features to aid retaining this portion within the body 2.

In molding the artificial bait material 10 depicted for example in FIG. 1A with a PLASTISOL material supplied to the mold 20 at between 345 degrees Fahrenheit and 365 degrees Fahrenheit, it was discovered that the in-body fusible bait thread 1b could advantageously be made to melt and form a balled or plug portion 1c near the end of the body 2 at which the fusible bait thread emerges (this effect is depicted, for example, in FIG. 1B). The balled portion 1c as depicted in FIG. 1B acts advantageously like a knot to secure the bait thread within the body 2. In order to achieve this effect, experimentation confirmed the importance of maintaining the temperature of the PLASTISOL material supplied to the mold 20 at between 345 degrees Fahrenheit and 365 degrees Fahrenheit. Temperatures below 345 degrees Fahrenheit did not result in sufficient melting of the in-body portion 1b of the fusible bait thread to form the balled portion 1c of FIG. 1B. And temperatures above 365 degrees Fahrenheit resulted in a weakening of the fusible bait thread 1b and eventual thread retention failure at the body 2.

It will be understood that, while various aspects of the present disclosure have been illustrated and described by way of example, the invention claimed herein is not limited thereto, but may be otherwise variously embodied within the scope of the following claims. For example, other moldable materials may be usable as alternatives to TPE materials, for example including liquid silicone rubber (LSR).

In addition to aspects of the present disclosure as embodied within the scope of the present claims, aspects of the present disclosure may be understood to embody:

A mold for manufacturing a one or more simulated bait assemblies each having a molded body and a thread component with a first portion that is integrally formed within the body and a second portion that extends out of and away from the body, the mold comprising: a feeder sprue extending through the mold for receiving an externally-supplied liquid material at the first edge and transferring the liquid material to the feeder sprue, one or more cavities each shaped to form a body of the simulated bait assembly, the one or more cavities positioned in fluid communication with the feeder sprue; and one or more channels each extending from one of the one or more cavities and terminating at an edge of the mold, the one or more channels each configured to receive a second thread portion of one of the one or more thread components.

The mold of paragraph [0050], further comprising a sprue seat in fluid communication with the feeder sprue and extending to a first edge of the mold for receiving a liquid material at the first edge and transferring the liquid material to the feeder sprue.

The mold of paragraph [0050], wherein the one or more channels extend along at least one outer surface of the mold.

The mold of paragraph [0052], further comprising a securement member for securing the one or more second thread portions on at least one of the at least one outer surfaces of the mold.

The mold of paragraph [0050], wherein each of the one or more cavities is shaped to form a molded body that simulates a worm.

A simulated bait assembly for attachment to a hook to form a fishing lure, the assembly comprising: a plurality of bodies each formed in a shape that simulates a predetermined bait type; and a plurality of thread components each having a first portion that is integrally formed within one of the bodies and a second portion that extends out of and away from a proximal end of the respective body.

The assembly of paragraph [0055], wherein each body comprises a thermoplastic material.

The assembly of paragraph [0056], wherein the thermoplastic material comprises a PLASTISOL material.

The assembly of paragraph [0057], wherein one or more additives selected from the group consisting of glitter, flecks, pearlescents, inks, dyes, scents and attractants are incorporated within the PLASTISOL material.

The assembly of paragraph [0055], wherein each thread component comprises a fusible thread.

The assembly of paragraph [0056], wherein each body is formed in a shape that simulates a worm.

The assembly of paragraph [0055], further comprising a central trunk comprising the thermoplastic material, the plurality of bodies each formed in integral contact with the central trunk at a distal end of the respective body and extending laterally away from the central trunk toward the proximal end of the respective body.

A method for making a fishing lure comprising a simulated bait assembly and a hook component, the simulated bait assembly configured for attachment to the hook component to form a fishing lure, the method comprising the steps of: 1) providing at least one simulated bait assembly, the at least one assembly comprising: a body formed in a shape that simulates a predetermined bait type, and a thread component having a first portion that is integrally formed within the body and a second portion that extends out of and away from the body; 2) providing a hook component having a shank portion; 3) positioning the second portion of the thread component of the at least one simulated bait assembly along the shank portion of the hook component; and 4) affixing the second portion of the thread component of the at least one simulated bait assembly along the shank portion of the hook component to produce the fishing lure.

The method of paragraph [0062], wherein the affixing step further comprises the steps of: wrapping a tying thread around the second portion of the thread component and the shank portion of the hook component to produce a predetermined number of wraps; and securing a wrapping end of the tying thread to the fishing lure.

The following table lists the reference characters and names of features and elements used herein: Reference characters assigned to method steps are not listed.

| Ref. char. | Feature or element |
|---|---|
| 1a | bait thread (external portion) |
| 1b | bait thread (in-body portion) |
| 1c | bait thread (balled portion) |
| 2 | body |
| 3 | fly tying thread |
| 4 | runner material |
| 5 | bobbin |
| 6 | hook |
| 7 | artificial bait element |
| 8 | fishing lure |
| 9 | thread spool |
| 10 | artificial bait material |
| 20 | mold |
| 21 | sprue |
| 22 | runner |
| 23a | primary channel |
| 23b | side channel |
| 24 | alignment aperture |
| 25 | alignment pin |
| 26 | cavity |
| 27 | first mold half |
| 28 | second mold half |
| 29 | aperture |

1. A simulated bait assembly for a fishing lure, the assembly comprising:
a body formed in a shape that simulates a predetermined bait type; and
a thread component having a first portion that is integrally formed within the body and a second portion that extends out of and away from the body.

2. The assembly of claim 1, wherein the body comprises a thermoplastic material.

3. The assembly of claim 2, wherein the thermoplastic material comprises a PLASTISOL material.

4. The assembly of claim 3, wherein one or more additives selected from the group consisting of glitter, flecks, pearlescents, inks, dyes, scents and attractants are incorporated within the PLASTISOL material.

5. The assembly of claim 3, wherein the thread component comprises a fusible thread.

6. The assembly of claim 5, wherein the body is formed in a shape that is configured to simulate a type of bait, or a characteristic or aspect of a type of bait.

7. The assembly of claim 6, wherein the body is formed in a shape that is configured to simulate a worm.

8. The assembly of claim 6, wherein the body is formed in a shape that is configured to simulate one or more of antennas, legs, and/or tail or trailing material of a type of bait.

9. The assembly of claim 7, wherein the body has two opposing ends and the thread extends out of and away from one of the two opposing ends.

10. The assembly of claim 7, wherein a part of the first portion of the fusible thread within and in proximity to the one end of the body from which the thread component extends is fused into an expanded, ball-like shape that anchors the thread component within the body.

11. A fishing lure, comprising:
a hook component; and
at least one simulated bait assembly according to claim 1, wherein the portion of the thread extending out of and away from the body of the at least on simulated bait assembly is secured to a shank portion of the hook component.

12. (canceled)

13. (canceled)

14. The assembly of claim 1, wherein the first portion of the thread includes one or more retention features for retaining the thread within the body.

15. The assembly of claim 14, wherein the one or more retention features comprise knots.

16. The assembly of claim 5, wherein the fusible thread is porous.

17. (canceled)

18. (canceled)

19. (canceled)

20. (canceled)

21. (canceled)

22. (canceled)
